(19) United States
(12) Patent Application Publication
(10) Pub. No.: US 2008/0280762 A1
(43) Pub. Date: Nov. 13, 2008

(54) Method of Enhancing Tomato Plant Growth

(76) Inventors: Paloma Melgarejo Nardiz, Madrid (ES); Antonieta De Cal Y Cortina, Madrid (ES); Pilar Sabuquillo Castrillo, Madrid (ES)

Correspondence Address: OSTROLENK FABER GERB & SOFFEN, 1180 AVENUE OF THE AMERICAS, NEW YORK, NY, 100368403, US

(21) Appl. No.: 12/093,984

(22) PCT Filed: Nov. 15, 2006
(86) PCT No.: PCT/ES2006/000624

§ 371 Date: Jun. 13, 2008

(30) Foreign Application Priority Data
Nov. 17, 2005 (ES) P200502822

(51) Int. Cl. A01N 63/04; A01P 21/00

(52) U.S. Cl. 504/117

(57) ABSTRACT

The method consists of placing the tomato seedlings in contact with a formulated Penicillium oxalicum conidia suspension when the plants are in the seed bed, such that the fungi generated by said conidia enhance the development or growth of the tomato seedlings.

### OBJECT OF THE INVENTION

This invention relates to a method of enhancing or promoting tomato plant growth.

The method consists of treating the plants in seed beds with a microorganism, specifically with Penicillium oxalicum, a fungus that colonises tomato plants, thereby enhancing the growth thereof.

### BACKGROUND OF THE INVENTION

The influence of microorganisms on plant growth is a well-known phenomenon in various microorganism-plant systems, such as the rhizobacteria-leguminosae symbiosis and other bacterial associations with different vegetable species (Spaink et al., 1998; Oke et al., 1999; Rai et al., 2000). Growth enhancement by means of different fungus genera has also been observed and various molecules have been isolated which have phytohormonal characteristics capable of causing this growth-enhancement effect on their own (Okon, 1994; Tikhonovich et al., 2004). The growth-enhancement effect is also a characteristic associated with many microorganisms that act as antagonists, inducing resistance against pathogen infections in plants (Murphy et al., 2000; Park et al., 2000; Zehnder et al., 2001; Tikhonovich et al., 2004). Penicillium oxalicum is a biocontrol agent for tomato vascular wilt induced by pathogens such as Fusarium oxysporum f. sp. lycopersici and Verticillium dahliae. Previous in vitro experiments have shown that the immersion of seeds of different tomato cultivars in P. oxalicum conidia suspensions for 30 minutes results in plants that exhibit faster development and a greater root weight than those not exposed to the fungus action (García-Lepe et al., 1996; Pascual, 1998). These assays evaluated growth enhancement in seeds treated and not treated with P. oxalicum and seeded in Petri dishes with different culture media. It has also been previously shown that the treatment of seeds with P. oxalicum is not the most adequate to control vascular wilt (De Cal et al., 1999). It has been shown that the best way to apply the conidia in order to control this disease in tomato plants is by means of irrigation to the roots in the seed bed one week prior to transplant (De Cal et al., 1999). Moreover, in the above-mentioned experiments, the conidia used were produced in an axenic laboratory medium, potato dextrose agar, which cannot be used at industrial scale.

### DESCRIPTION OF THE INVENTION

The method proposed by the invention proves growth enhancement in tomato plants planted in seed beds and treated with Penicillium oxalicum. This method of application is simple and may be performed under real cultivation conditions, whilst the conidia are produced by a method that may be easily scaled to industrial level.

The conidia are presented in a dry formulation that is stable and easy to apply under practical conditions, and the growth enhancement is related to the biocontrol of tomato vascular wilts.

More specifically, the method consists of placing the plants in contact with the conidia, specifically with the former in the seedling phase, in the pertinent seed bed, with a final concentration of between 1×10⁶ and 10×10⁶ conidia per gram in the seed bed substrate.

The application in suspension may be performed by direct spraying on the seedlings or by irrigation of the soil.

### DESCRIPTION OF THE DRAWINGS

In order to complement the description being made and to contribute to a better understanding of the characteristics of the invention, in accordance with a preferred practical embodiment example thereof, a set of drawings is attached as an integral part of said description, where, for illustrative purposes, but not limited thereto, the following is represented:

FIG. 1 shows two photographs of tomato plant seed beds, those on the left treated with “penicillium oxalicum”, and those on the right not treated;

FIG. 2 shows photographs of tomato seedlings, those on the right treated with Penicillium oxalicum conidia in the seed bed, and those on the left not treated;

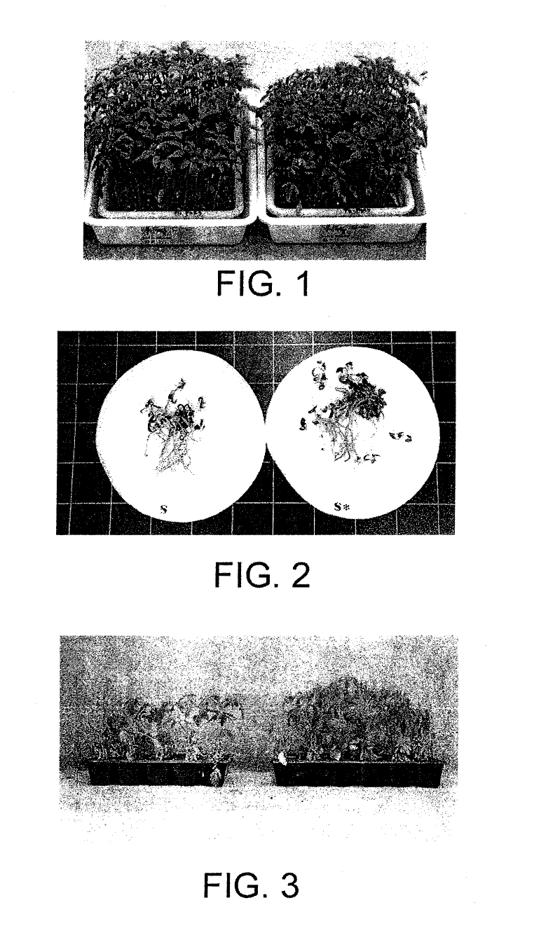

Finally, FIG. 3 shows photographs of tomato plants transplanted to pots, those on the right previously treated with Penicillium oxalicum conidia in the seed bed, and those on the left not treated.

### PRACTICAL EMBODIMENT EXPERIMENT FOR THE INVENTION

P. oxalicum isolate (PO-212) is currently found in the American Culture collection and has number ATCC 201888. It is stored in tubes with potato dextrose agar at 4° C. and, for the initial production of conidia, is grown in Petri dishes with PDA at 20-25° C. for 7 days in the dark. The conidia used to perform the growth enhancement experiments are produced and formulated in the following manner. The fungus is grown in a mixture of peat (Gebr. BRILL substrate GmbH&Co., Germany): vermiculite (Termita, Asfaltex, S.A., Barcelona, Spain): lentil flour (1:1:0.5, w/w/w). Fifty grams of this substrate (with a 40% w/w water content) are introduced in plastic bags (600 cm³) designed for solid fermentation (VALMIC®, Sacherei de Pont-Audemer S.A., France), sealed and autoclave-sterilised at 1.0 kg cm⁻² and 120° C. for 1 h and 3 consecutive days. The bags are then inoculated with a suspension of P. oxalicum conidia produced in potato dextrose agar at a concentration such that 10⁵ conidia g⁻¹ dry substrate are obtained; they are once again sealed and incubated in the dark at 20-25° C. for 5 days. Water is added to this mixture of conidia+substrate in a 1:4, w/v, proportion. This suspension is mixed in an orbital shaker (Lab-Line Instruments, Inc., model 3527, Melrose Park, Ill., USA) at 200 rpm for 10 min and filtered with glass wool. Most of the conidia pass through it and the conidia suspension collected is concentrated by centrifugation at 10,000 rpm for 10 min and vacuum-filtering through filter paper (1 μm). The final yield of conidia obtained following this process is 10⁸ conidia g⁻¹ dry weight of substrate. These conidia have a mean viability of 80%. The formulated conidia (FOR4) are obtained by adding sodium alginate to the P. oxalicum conidia paste obtained following the extraction described above. The P. oxalicum conidia are kept in a 1.5% sodium alginate solution for 10 minutes and are vacuum filtered through filter paper (1 μm). Once filtered, the formulated and unformulated conidia are dried in a fluid bed until the humidity thereof is less than 10%. In order to dry it, the conidia paste is introduced in a fluid bed, model 350s (Burkhard Manufacturing Co. Ltd., Hertfordshire, UK), at the maximum air flow and 40° C. for the necessary time to achieve the required humidity.

cv. San Pedro tomato seeds were seeded in trays (27×42×7 cm) containing an autoclaved mixture of vermiculite and peat (1:1, v:v). The trays were kept in a growth chamber with fluorescent light (100 μE/m² s, 16 h photoperiod) at 22-28° C. and 80%-100% relative humidity for 3 weeks. At this time, the seedlings had 2-4 leaves and received irrigation in the seed bed with a formulated P. oxalicum conidia suspension at a concentration such that the final concentration in the seed bed substrate (vermiculite:peat, 1:1 v/v) was 6×10⁶ conidia g⁻¹. The control treatment consisted of irrigating the seedlings only with sterile distilled water. Once treated, the seed bed trays were transported to a greenhouse, where they were kept for 7 days, following which the seedlings were transplanted to their settlement soil. At this time, the plants were carefully removed from the seed bed, separating the aerial part from the roots. The total number of leaves of 10 plants per treatment was counted, and the roots of 3 plants per treatment were separately weighed. The data were analysed by means of variance analysis. When the F test was significant (P=0.05), the means were compared by the Student-Newman-Keul test (P=0.05).

The results of the assay are shown in Table 1.

TABLE 1
Effect of treatment with Penicillium
oxalicum conidia on the growth of cv San Pedro tomato
plants.

| Treatment | Root weight (mg) | No. leaves |
|---|---|---|
| Penicillium | 800 ± 60 | 30 |
| oxalicum | | |
| Untreated control | 430 ± 30 | 29 |

As can be seen, the number of leaves is greater in the treated plants and the root weight is doubled.

1. Method of enhancing tomato plant growth, wherein it consists of placing the tomato plants in contact with Penicillium oxalicum conidia.

2. Method of enhancing tomato plant growth, according to claim 1, wherein the conidia, stored in the form of dry paste, are introduced in a sodium alginate solution, dried in a fluid bed until a humidity of less than 10% is obtained, and applied to the tomato plants or to the soil where they are planted.

3. Method of enhancing tomato plant growth, according to claim 1, wherein the conidia concentration is between 1×10⁶ and 10×10⁶ conidia per gram.
